(19) United States
(12) Patent Application Publication
(10) Pub. No.: US 2003/0042913 A1
(43) Pub. Date: Mar. 6, 2003

(54) Method for measuring the electrical characteristics of a telecommunication cable

(75) Inventor: Jean Bussinger, Saint Anastasie Sur Issole (FR)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: SOCRAT

(21) Appl. No.: 10/226,385

(22) Filed: Aug. 23, 2002

Related U.S. Application Data
(63) Continuation of application No. PCT/FR01/00348, filed on Feb. 7, 2001.

(30) Foreign Application Priority Data
Feb. 23, 2000 (FR) 00 02222

(51) Int. Cl. H04B 3/46; H01H 31/02

(52) U.S. Cl. 324/541

(57) ABSTRACT

The present invention relates to a method for measuring the electrical characteristics of a telecommunication cable (10) comprising a bundle of electric wires (11) conveying a service voltage (U) delivered by equipment (15) referenced to ground, arranged in an insulating sheath comprising a conductive screen (12). According to the present invention, the method comprises one step of measuring the insulation resistance (Rᵢₛₒ) of the screen (12) relative to the ground, one step of measuring the electric potential (Pₑ) of the screen (12) relative to the ground, and one step of determining a global insulation resistance (Rᵢ) of the bundle of electric wires (11) relative to the conductive screen (12), using the result of the measurements of the insulation resistance (Rᵢₛₒ) and of the electric potential (Pₑ) of the screen. Application to characterising or to maintaining telecommunication cables.

The present invention relates to a method for measuring the electrical characteristics of a telecommunication cable comprising a bundle of electric wires presumed to be insulated from each other by a suitable wrapping, arranged in an insulating sheath comprising a conductive screen.

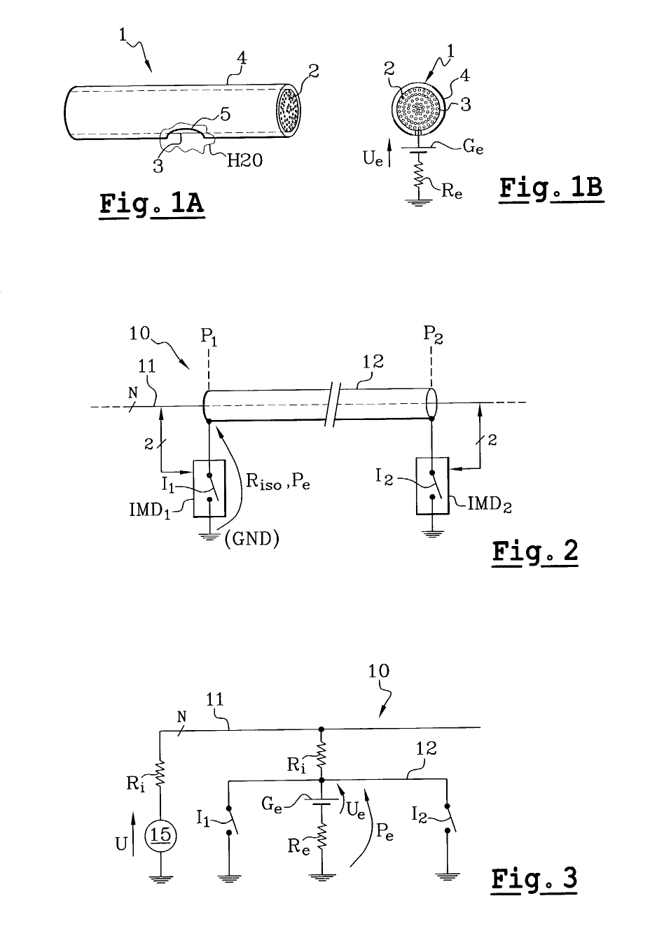

Current telecommunication networks, that have a tree structure, are produced by means of cables 1 with a large section of the type represented in FIG. 1A, comprising several hundred or thousand electric wires 2 insulated from each other by a suitable wrapping and arranged two by two to form telephone pairs. The assembly is protected from electric disturbance by a metal sheath, or screen 3, and is wrapped in a protective sheath 4 made of an electrically insulating material such as polyethylene, PVC, . . .

Such telecommunication cables, arranged in the ground or in the air, are subjected to various attacks the most frequent of which are caused by lightning, rodents, road works, the rubbing of tree branches . . . These various attacks can lead to a tear 5 of the sheath 4 and to the penetration of water into the cable. From an electrical point of view, such deterioration results in an insulation defect of the screen 3 in relation to the ground, represented in a diagram in FIG. 1B by a resistance Rₑ, and by the occurrence of a voltage Uₑ, or “electrochemical couple”, generated in particular by the combination of the water and the metal of the screen 3. The electrochemical couple Uₑ, represented in FIG. 1B by a voltage generator Ge, does not, in practice, exceed 1 to 1.5 Volts. When a tightness defect is not repaired in time, the deterioration of the cable extends to the wrapping of the electric wires and develops over a substantial length of the cable due to the spread of water in the cable.

In recent years, the applicant has designed, developed and perfected an automatic surveillance system for telecommunication networks comprising a set of measuring devices marketed under the reference “IMD” (Interface de Mesure Déportée—Remote Measuring Interface). Such devices, described in the patent EP 408 480 and in the application PCT/FR99/02288, are arranged at connection points to the ground of the conductive screens and linked by telephone pairs to local maintenance equipment, that is itself linked to a regional maintenance centre. The IMD devices allow the screens to be disconnected from the ground and various measurements to be performed aiming to detect an insulation defect. These measurements comprise measuring the insulation resistance of the screens relative to the ground, designated hereinafter by the resistance Rᵢₛₒ, and measuring the electric potential Pₑ of the screen relative to the ground, considered up to now to be representative of the electrochemical couple Uₑ. The IMD devices also allow the electrical continuity of the screens to be checked by the “ground loop” method, and an insulation defect to be located by means of a method described in application PCT/FR99/02288.

At the same time, the rapid development of computer networks, particularly the Internet, has led to a growing need to have efficient means to characterise telecommunication cables with a view to qualifying them to transport broadband digital signals. These computer networks rely on telecommunication cable infrastructures most of which have existed for several years, the electrical characteristics of which must, in principle, be rigorously checked before they are allocated to the transport of broadband digital signals. For example, an xDSL-type (“Digital Subscriber Line”) network requires a bandwidth that is two hundred times more extensive than the ordinary telephone band and uses very low level signals, which means screens with perfect electrical continuity and telephone pairs that have not been damaged by a tightness defect are required.

To meet this need, the applicant suggests fitting IMD devices into existing networks of cable, as a means for characterising cables before they are allocated to the transport of digital data. Once the validity of the cables has been checked, the IMD devices can be used in a more classical way as a means for checking the quality of the cables and for maintenance. The parameters or characteristics that can be measured by means of IMD devices to qualify telecommunication cables are:

the insulation resistance Rᵢₛₒ of screens relative to the ground,

the screen potential Pₑ, and

the electrical continuity of screens, which guarantees the flow of electric charges induced by electromagnetic disturbance or rises in the electric potential in the ground.

However, the problem posed by fitting IMD devices into networks of old cables that have not previously been checked is that such measures do not allow the condition of the cable core to be known, i.e. whether the insulation provided by the wrapping of the electric wires is valid. In fact, the measurement of a low insulation resistance Rᵢₛₒ shows that a cable has a tightness defect but does not show how long such a defect has existed or whether the wrapping of the wires has been attacked. The penetration of water into a cable does not immediately make the cable unfit to transport digital data, as several months can pass before the wrapping of the electric wires itself is attacked. This problem does not arise when IMD devices are fitted into a network of new cables as any penetration of water is detected rapidly and a repair is carried out before the wrapping of the wires is damaged.

The object of the present invention is to overcome this inconvenience.

More particularly, the object of the present invention is to provide a method and means for assessing the condition of the wrapping of the wires present in a telecommunication cable, using external measurements concerning the electrical characteristics of the screen of the relevant cable.

To achieve this object, the present invention is initially based on the fact that the wires of a telecommunication cable convey, to provide the telephone service, a significant service voltage, generally 48 V, delivered by equipment referenced to ground. Secondly, the present invention is based on the premise according to which a bundle of electric wires considered as a whole has a determined insulation resistance in relation to the screen surrounding it, and that the deterioration of the wrapping of at least one wire conveying the service voltage must inevitably lead to an abnormal rise in the screen potential Pₑ. According to the present invention, a parameter called the “global insulation resistance” of the bundle of wires is therefore defined relative to the screen, and the electrical characteristics of a telecommunication cable are modelled so as to take such global insulation resistance into account. After various calculations and developments of equations that will be described below, a mathematical expression is obtained that allows the global insulation resistance to be calculated using measurable parameters such as the insulation resistance Rᵢₛₒ of the screen and the screen potential Pₑ. Such a calculation of the global insulation resistance using external measurements constitutes simple and practical means of assessing the internal condition of a cable.

Therefore, the present invention provides a method for measuring the electrical characteristics of a telecommunication cable, the cable comprising a bundle of electric wires conveying a service voltage delivered by equipment referenced to ground, the electric wires being presumed to be insulated from each other by a suitable wrapping, the bundle of wires being arranged in an insulating sheath comprising a conductive screen, a method comprising one step of measuring the insulation resistance of the screen relative to the ground, one step of measuring the electric potential of the screen relative to the ground, and one step of determining a global insulation resistance of the bundle of electric wires relative to the conductive screen, using the result of the measurements of the insulation resistance and of the electric potential of the screen.

According to one embodiment, the global insulation resistance is determined by means of the following relation or any other equivalent relation: [Rᵢ=Rᵢₛₒ/(Pₑ−k)], “Rᵢ” being the global insulation resistance, “U” the service voltage, “Rᵢₛₒ” the insulation resistance of the screen, “Pₑ” the potential of the screen and “k” a constant.

According to one embodiment, when the potential of the screen is not zero but below a determined value, the constant “k” is considered equal to the potential of the screen and the global insulation resistance is considered mathematically infinite.

According to one embodiment, the method also comprises one step of determining an external insulation resistance of the screen relative to the ground, by means of the following relation or any other equivalent relation: [Rₑ=Rᵢₛₒ/(U−Pₑ)], “Rₑ” being the external insulation resistance of the screen, “U” the service voltage, “Rᵢₛₒ” the insulation resistance of the screen, “Pₑ” the potential of the screen and “k” a constant.

According to one embodiment, when the electric potential of the screen is below a determined value, the constant “k” is considered equal to the potential of the screen and the external insulation resistance is considered equal to the insulation resistance of the screen.

According to one embodiment, the -insulation resistance of the screen and the potential of the screen are measured by means of measuring devices arranged at points of origin and end points of the cable, remote-controlled by means of telephone wires.

According to one embodiment, the global insulation resistance is determined by local or regional maintenance equipment comprising means for communicating by telephone with the measuring devices.

The present invention also relates to a method for characterising and/or maintaining a telecommunication cable comprising a bundle of electric wires conveying a service voltage delivered by equipment referenced to ground, the electric wires being presumed to be insulated from each other by a suitable wrapping, the bundle of wires being arranged-in an insulating sheath comprising a conductive screen, a method comprising one step of measuring the electrical characteristics of the cable carried out in compliance with the method described above, allowing a global insulation resistance of the bundle of electric wires to be determined relative to the conductive screen.

According to one embodiment, the method comprises one step of repairing or replacing a cable when the global insulation resistance of the bundle of wires is below a determined value.

The present invention also relates to a system for characterising and/or maintaining a network of telecommunication cables, comprising measuring devices connected at points of origin and end points of telecommunication cables, maintenance equipment comprising means for communicating with the measuring devices, and means for measuring the electrical characteristics of a telecommunication cable of the network or of one portion of network constituted by cables linked together, the cable or the portion of network comprising a bundle of electric wires conveying a service voltage delivered by equipment referenced to ground, the electric wires being presumed to be insulated from each other by a suitable wrapping, the bundle of wires being arranged in an insulating sheath comprising a conductive screen, a system in which the maintenance equipment is arranged to measure the insulation resistance of the screen relative to the ground, to measure the electric potential of the screen relative to the ground, and to determine a global insulation resistance of the bundle of electric wires relative to the conductive screen, using the result of the measurements of the insulation resistance and of the electric potential of the screen.

These and other objects, advantages and features of the present invention shall be explained in greater detail in the following description of the measuring method according to the present invention and of an example of embodiment of a system for characterising and/or maintaining a network of telecommunication cables according to the present invention, in relation with the following figures, in which:

FIGS. 1A and 1B described above represent a telecommunication cable with a tightness defect,

FIG. 2 shows the implementation of the method of the present invention on a telecommunication cable,

FIG. 3 is a wiring diagram according to the present invention of the cable in FIG. 2,

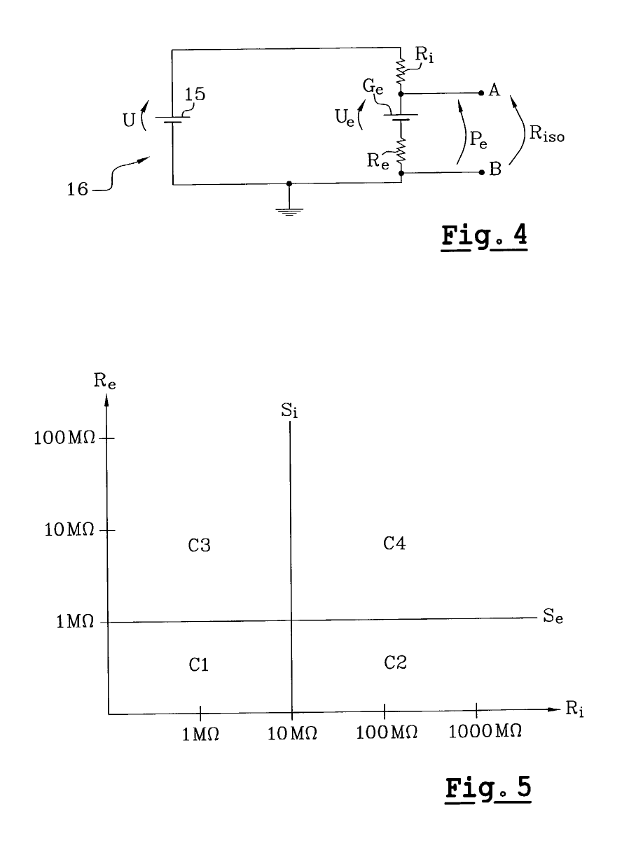

FIG. 4 is the equivalent wiring diagram of the diagram in FIG. 3,

FIG. 5 is a diagram showing the classification of results of measurements and calculations carried out in compliance with the method according to the present invention, and

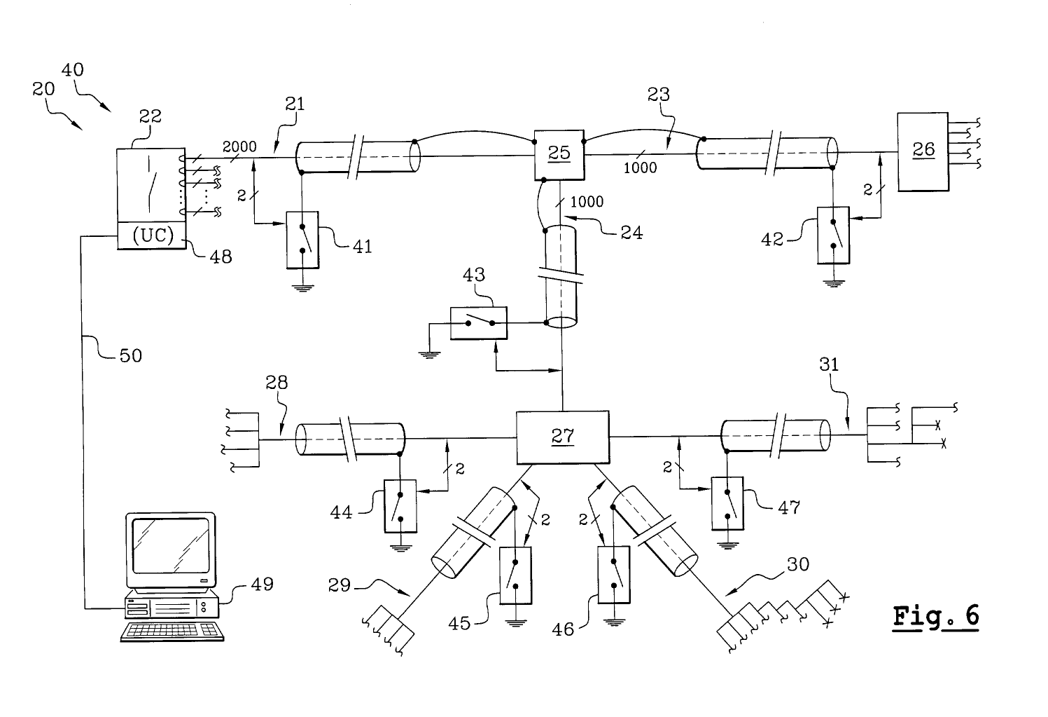

FIG. 6 schematically represents a network of telecommunication cables comprising a characterisation and/or maintenance system according to the present invention.

FIG. 2 shows the practical details of the implementation of the method according to the present invention and schematically represents a telecommunication cable 10 comprising a bundle 11 of electric wires. The bundle 11, which comprises for example N wires forming N/2 telephone pairs, is surrounded by a conductive screen 12 forming shielding and by an insulating sheath (not shown) . The points of origin P1 and end points P2 of the screen 12 are connected to the ground (GND) by means of two switches, respectively I1, I2. These switches are present here inside two devices IMD1, IMD2 of the type marketed by the applicant, remote-controlled by means of a telephone pair.

During a first measuring step, the switches I1 and I2 are open and the screen 12 is disconnected from the ground. One of the IMD devices, for example the device IMD1, measures the insulation resistance Rᵢₛₒ and the electric potential Pₑ of the screen relative to the ground.

This first step of the method of the present invention is, in itself, similar to the one in the maintenance method developed in recent years by the applicant. Until now, the measuring of a low insulation resistance Rᵢₛₒ led to the conclusion that there was penetration of water or damp due to a tear in the sheath or to a tightness defect of a connection box. Also the existence of a non-zero screen potential Pₑ in the order of 1 to 1.5 Volt was interpreted as representative of the existence of an electrochemical couple Uₑ due to oxidation caused by penetration of water or damp.

The present invention does not question these interpretations of measurements but provides, on the contrary, as shown in FIG. 3, a model of the electrical characteristics of the cable that is more complete than the previous one (FIG. 1B). This model takes into account the existence of a “global insulation resistance” Rᵢ of the bundle of wires 11 relative to the screen 12, and the fact that the bundle of wires 11 conveys a service voltage U, generally in the order of 48 V. This voltage U is delivered by a voltage generator 15 referenced to ground, having a series resistance ri here considered negligible. The generator 15 is, in practice, an autoswitch present in a telecommunication centre, which biases one wire of each telephone pair with the voltage U.

Therefore, in the diagram in FIG. 3, the bundle of wires 11 (schematically represented in the form of a single wire) is linked to the screen 12 by means of the global insulation resistance Rᵢ. The screen 12 is linked to the ground by means of a voltage generator Ge that delivers the electrochemical couple Uₑ and of a resistance Rₑ, that will be called “external insulation resistance” of the screen 12. It should be noted here that the measurable insulation resistance Rᵢₛₒ was considered in previous practices to be the external insulation resistance Rₑ. However, according to the model represented in FIG. 3, the resistance Rᵢₛₒ now comprises the resistances Rᵢ and Rₑ in parallel.

For a better understanding, FIG. 4 represents the equivalent diagram 16 of the model in FIG. 3. The diagram 16 is a conduction loop passing through the ground comprising the following elements in series:

the generator 15, delivering the voltage U,

the global insulation resistance of the wires Rᵢ,

the generator Ge delivering the voltage Uₑ, and

the external insulation resistance of the screen Rₑ.

Two points A and B, between which the generator Ge and the resistance Rₑ are located, mark the measuring points of the screen potential Pₑ and of the resistance Rᵢₛₒ (the respective positions of the generator Ge and of the resistance Rₑ between the points A, B can be inverted without any change to the mathematical relations described below).

It will now be shown that the measurement of the screen potential Pₑ and of the insulation resistance Rᵢₛₒ allows the global insulation resistance Rᵢ and the external insulation resistance Rₑ to be determined. In accordance with the principle of superposition of currents, the screen potential Pₑ complies with the following relation:

Pₑ=U1+U2 (1)

and is equal to the sum of a voltage U1 occurring in the absence of electrochemical couple Uₑ and of a voltage U2 occurring in the absence of the service voltage U. As the resistances Rᵢ and Rₑ form a voltage dividing bridge, the respective expressions of the voltages U, U2 are as follows:

U1=U Rₑ/(Rₑ+Rᵢ) (2)

U2=Uₑ[1−(Rₑ/Rₑ+Rᵢ)]=Uₑ Rᵢ/(Rₑ+Rᵢ) (3)

from which:

Pₑ=U Rₑ/(Rₑ+Rᵢ)+Uₑ Rᵢ/(Rₑ+Rᵢ) (4)

The expression of Rₑ is deduced according to Rᵢ, Pₑ and Uₑ:

Rₑ=Rᵢ (Pₑ−Uₑ)/(U−Pₑ) (5)

Furthermore, the resistance Rᵢₛₒ is constituted by the resistances Rᵢ and Rₑ in parallel, i.e.:

Rᵢₛₒ=(Rᵢ Rₑ)/(Rᵢ+Rₑ) (6)

The expression of Rᵢ is deduced according to Rₑ and Rᵢₛₒ:

Rᵢ=Rᵢₛₒ Rₑ/(Rₑ−Rᵢₛₒ) (7)

By injecting the relation (5) into the relation (7), the result is:

Rᵢ=Rᵢₛₒ Rᵢ (Pₑ−Uₑ)/[(Rᵢ(Pₑ−Uₑ)−(U Rᵢₛₒ)+(Pₑ Rᵢₛₒ)] (8)

I.e.:

Rᵢ[Rᵢ (Pₑ−Uₑ)−Rᵢₛₒ(U−Uₑ)]=0 (9)

As the resistance Rᵢ is not zero, the expression of Rᵢ is deduced according to the parameters U, Uₑ, Pₑ and Rᵢₛₒ:

Rᵢ=Rᵢₛₒ (U−Uₑ)/(Pₑ−Uₑ) (10)

By injecting the relation (10) into the relation (5), the result is:

Rₑ=Rᵢₛₒ [(U−Uₑ)/(Pₑ−Uₑ)] [(Pₑ−Uₑ)/(U−Pₑ)] (11)

The simplification of the relation (11) gives the expression of Rₑ according to the parameters U, Uₑ, Pₑ and Rᵢₛₒ:

Rₑ=Rᵢₛₒ (U−Uₑ)/(U−Pₑ) (12)

After all is said and done, the relations (10) and (12) allow the insulation resistances Rᵢ and Rₑ to be calculated according to the parameters U, Uₑ, Pₑ and Rᵢₛₒ.

Now, the voltage U is known and the screen potential Pₑ and the resistance Rᵢₛₒ have been measured by means of devices IMD1, IMD2 in the first step of the method of the present invention. The electrochemical couple Uₑ is however, not known. To calculate the insulation resistances Rᵢ and Rₑ, two cases are therefore considered that can be encountered in practice.

In a first case, the screen potential Pₑ is low and does not exceed 1 to 1.5 V. It is deduced that the screen potential Pₑ is equal to the electrochemical couple Uₑ and that the cable 10 has undergone external deterioration of the sheath that has not yet affected the wrapping of the electric wires of the bundle of wires 11. The relations (10) and (12) can be simplified and give the following results:

Rᵢ≈∞

Rᵢₛₒ≈Rₑ

This case corresponds to previous practices, in which it was always considered that the screen potential Pₑ was representative of the electrochemical couple Uₑ and that the insulation resistance Rᵢₛₒ was representative of the external insulation resistance Rₑ.

In a second case, the screen potential Pₑ is above approximately 1.5 V and therefore is not exclusively linked to the existence of an electrochemical couple Uₑ. That means that the wrapping of the wires is attacked by penetration of water or damp, that the wires are no longer properly insulated in relation to the screen and that one part of the service voltage U is on the screen. By considering in this case that the electrochemical couple Uₑ is negligible before the voltage U, the relation (12) is simplified and gives the value of the external insulation resistance Rₑ according to the known parameters U, Pₑ and Rᵢₛₒ:

(12) [symbol] (13) Rₑ=Rᵢₛₒ U/(U−Pₑ)

by injecting the relation (13) into the relation (7), a simplified form of the relation (10) is deduced:

(10) [symbol] (14) Rᵢ=Rᵢₛₒ U/Pₑ

The calculation of the resistances Rₑ and Rᵢ according to the relations (13) and (14) is, it will be understood, approximate since the electrochemical couple Uₑ is disregarded. However, this approximation is all the more minor as the screen potential Pₑ is high. Furthermore, as the object of the method of the present invention is to assess the condition of a cable, this approximation is sufficient to characterise the cable and settle the question of whether the cable must be repaired immediately or can still be used for a few months. This allows, in particular, the repairs to be planned and the most urgent ones to be carried out.

As an example, FIG. 5 represents a characterisation diagram comprising a scale of global insulation resistance Rᵢ values on abscissa and a scale of external insulation resistance Rₑ values on ordinate. In this diagram there are four conditions C1 to C4 leading to different conclusions as far as the cable validity is concerned. These conditions are delimited on abscissa by a threshold Sᵢ (resistance Rᵢ) and on ordinate by a threshold Sₑ (resistance Rₑ). Table 1 below describes the characteristics of each condition, the threshold Sᵢ here being chosen equal to 10 MΩ and the threshold Sₑ equal to 1 MΩ.

Preferably, the electrical continuity is checked in all the cases mentioned in table 1 by means of the classical ground loop method. For example, in FIG. 2, the device IMD1 maintains the point of origin P1 of the screen 12 connected to the ground while the device IMD2 disconnects the end point P2. The device IMD2 measures the resistance of the loop constituted by the resistance of the screen 12, the ground resistance of the device IMD1 and its own ground resistance. If the loop resistance is very high, that means that the screen 12 has a continuity defect or that the ground resistance of one of the devices IMD1, IMD2 is faulty.

TABLE 1

| Cond | Rₑ | R₁ | Conclusions on the condition of the cable |
|---|---|---|---|
| C1 | ≦Se | ≦Si | Poor tightness - Cable core damaged - Dubious |
| | | | performances - Immediate repair recommended. |
| C2 | ≦Se | >Si | Poor tightness but cable core in good condition- |
| | | | Performances guaranteed for the moment but |
| | | | deterioration foreseeable in a few months. |
| C3 | >Se | ≦Si | Good tightness but cable core damaged - Dubious |
| | | | performances - Immediate repair recommended. |
| C4 | >Se | >Si | Good tightness and cable core in good condition - |
| | | | Performances guaranteed |

It will be understood that the calculation method of the resistances Rₑ and Rᵢ is susceptible of variations and improvements. Generally speaking, it is possible to define a corrective constant k representing the electrochemical couple Uₑ, the relations (10) and (12) then being:

(10) [symbol] (15) Rᵢ=Rᵢₛₒ (U−k)/(Pₑ−k)

(12) [symbol] (16) Rₑ=Rᵢₛₒ (U−k)/(U−Pₑ)

It becomes apparent that the relations (14) and (13) are particular cases of the relations (15) and (16) when the constant k is chosen to be equal to 0.

Regardless of the method chosen (constant k equal or different to 0), the method according to the present invention, based on the model described above, provides the advantage of allowing a telecommunication cable to be completely characterised thanks to the determination of the global insulation resistance Rᵢ. Moreover, this method allows the external insulation resistance Rₑ, which, in previous practices, was confused with the insulation resistance measured Rᵢₛₒ to be calculated with greater accuracy.

FIG. 6 represents one example of a characterisation and/or maintenance system 40 according to the present invention, which is integrated into a network of telecommunication cables 20 (partially represented). The network 20 comprises for example a primary cable 21 comprising 2,000 telephone pairs, connected at its point of origin to one terminal of an autoswitch 22. The primary cable 21 is divided into two other primary cables 23, 24 comprising 1,000 telephone pairs each, by means of a splice box 25 providing the electrical continuity of the screens. The end of each cable 23, 24 is connected to a cross-connect cabinet, respectively 26, 27, from which secondary cables start. For example, the cable 24 is divided after the cabinet 27 into four secondary cables 28 to 31 comprising 250 telephone pairs each. The secondary cables 28 to 31 are themselves divided into cables of a smaller section comprising a plurality of subdivisions leading to terminal boards to which the subscribers are connected, shown in the diagram by crosses.

The characterisation and/or maintenance system 40 comprises IMD devices referenced 41 to 47, local maintenance equipment UC (Central Processing Unit) taking the form of a slide-in chassis 48 arranged in the autoswitch 22, and regional maintenance equipment 49. The regional equipment 49 communicates with the local equipment 48 by means of a data transmission link 50 located upstream from the autoswitch 22. The IMD devices provide the connection to the ground of the screens to which they are connected. The device IMD 41 is arranged at the point of origin of the cable 21. The IMD devices 42, 43 are arranged at the end points of the cables 23, 24, at the cabinets 26, 27. The IMD devices 44 to 47 are arranged at the points of origin of the secondary cables 28 to 31, the ends of which, leading to the subscribers' terminal boards, are not connected to the ground. Each device IMD 41 to 47 is controlled by the local equipment 48 by means of a single telephone pair (one telephone pair currently allowing up to 16 IMD devices to be controlled).

The characterisation and/or maintenance system 40 that has just been described is, in its structure, similar to those already implemented by the applicant in previous practices. It differs from previous practices by the fact that the measurements of screen potential Pₑ and insulation resistance Rᵢₛₒ are used in compliance with the method of the present invention to calculate the global insulation resistance Rᵢ of the core of cables and to calculate the external insulation resistance Rₑ of the screens. The calculation of the resistances Rᵢ and Rₑ using the parameters measured Pₑ and Rᵢₛₒ (the service voltage U delivered by the autoswitch 22 being known) is provided by the local equipment 48, which sends the results to the regional equipment 49. This calculation can also be provided by the regional equipment 49, the local equipment 48 being limited in this case to sending the parameters Pₑ, Rᵢₛₒ measured by means of IMD devices to the equipment 49.

It can be seen in FIG. 6 that the measurements of the parameters Pₑ, Rᵢₛₒ and the calculation of the resistances Rᵢ, Rₑ here concern entire portions of network. For example, a measurement taken by disconnecting the IMD devices 41, 42, 43 from the ground allows the resistances Rᵢ, Rₑ to be determined in the primary network comprising the cables 21, 23, 24 and the splice box 25. Also, a measurement taken by disconnecting one of the IMD devices 44 to 47 from the ground allows the resistances Rᵢ, Rₑ to be determined in the section of secondary network comprising one of the cables 28 to 31 and the branches leading to the subscribers. Furthermore, an insulation defect detected in the network can be accurately located by means of the location method described in application PCT/FR99/02288.

In compliance with table 1 described above, the calculation of the resistances Rᵢ, Rₑ shows whether the section of network tested can be operated, at least temporarily, to distribute broadband digital signals.

It will be understood by those skilled in the art that the method according to the present invention is susceptible of various applications and embodiments. In particular, the parameters Pₑ, Rᵢₛₒ allowing the resistances Rᵢ, Rₑ to be determined can be measured by any type of device, manual or automatic, other than IMD devices.

1. Method for measuring the electrical characteristics of a telecommunication cable (10, 21, 23, 24, 28-31), the cable comprising a bundle of electric wires (11) conveying a service voltage (U) delivered by equipment (15, 22) referenced to ground, the electric wires being presumed to be insulated from each other by a suitable wrapping, the bundle of wires (11) being arranged in an insulating sheath comprising a conductive screen (12), characterised in that it comprises:
one step of measuring the insulation resistance (Rᵢₛₒ) of the screen (12) relative to the ground,
one step of measuring the electric potential (Pₑ) of the screen (12) relative to the ground, and
one step of determining a global insulation resistance (Rᵢ) of the bundle of electric wires (11) relative to the conductive screen (12), using the result of the measurements of the insulation resistance (Rᵢₛₒ) and of the electric potential (Pₑ) of the screen.

2. Method according to claim 1, characterised in that the global insulation resistance (Rᵢ) is determined by means of the following relation or any other equivalent relation:
Rᵢ=Rᵢₛₒ (U−k)/(Pₑ−k)
“Rᵢ” being the global insulation resistance, “U” the service voltage, “Rᵢₛₒ” the insulation resistance of the screen, “Pₑ” the potential of the screen and “k” a constant.

3. Method according to claim 2, in which, when the potential (Pₑ) of the screen is not zero but below a determined value, the constant “k” is considered equal to the potential of the screen and the global insulation resistance (Rᵢ) is considered mathematically infinite.

4. Method according to one of claims 1 to 3, characterised in that it also comprises one step of determining an external insulation resistance (Rₑ) of the screen (12) relative to the ground, by means of the following relation or any other equivalent relation:
Rₑ=Rᵢₛₒ (U−k)/(U−Pₑ)
“Rₑ” being the external insulation resistance of the screen, “U” the service voltage, “Rᵢₛₒ” the insulation resistance of the screen, “Pₑ” the potential of the screen and “k” a constant.

5. Method according to claim 4, in which, when the electric potential (Pₑ) of the screen is below a determined value, the constant “k” is considered equal to the potential (Pₑ) of the screen and the external insulation resistance (Rₑ) is considered equal to the insulation resistance (Rᵢₛₒ) of the screen.

6. Method according to one of claims 1 to 5, characterised in that the insulation resistance (Rᵢₛₒ) of the screen and the potential (Pₑ) of the screen are measured by means of measuring devices (IMD1, IMD2, 41-47) arranged at points of origin and end points of the cable, remote-controlled by means of telephone wires.

7. Method according to claim 6, characterised in that the global insulation resistance (Rᵢ) is determined by local or regional maintenance equipment (UC, 48, 49) comprising means for communicating by telephone with the measuring devices (41-47).

8. Method for characterising and/or maintaining a telecommunication cable (10, 21, 23, 24, 28-31) comprising a bundle of electric wires (11) conveying a service voltage (U) delivered by equipment (15, 22) referenced to ground, the electric wires being presumed to be insulated from each other by a suitable wrapping, the bundle of wires (11) being arranged in an insulating sheath comprising a conductive screen (12), a method characterised in that it comprises one step of measuring the electrical characteristics of the cable (10, 21, 23, 24, 28-31) carried out in compliance with the method according to one of claims 1 to 7, allowing a global insulation resistance (Rᵢ) of the bundle of electric wires to be determined relative to the conductive screen.

9. Method according to claim 8, characterised in that it comprises one step of repairing or replacing a cable when the global insulation resistance (Rᵢ) of the bundle of wires is below a determined value (Si).

10. System for characterising and/or maintaining (40) a network of telecommunication cables, comprising measuring devices (IMD, 41-47) connected at points of origin and end points of telecommunication cables (21-24, 28-31), maintenance equipment (UC, 48, 49) comprising means for communicating with the measuring devices, and means for measuring the electrical characteristics of a telecommunication cable (10, 21, 23, 24, 28-31) of the network or of one portion of the network constituted by cables linked together, the cable or the portion of network comprising a bundle of electric wires (11) conveying a service voltage (U) delivered by equipment (15, 22) referenced to ground, the electric wires being presumed to be insulated from each other by a suitable wrapping, the bundle of wires (11) being arranged in an insulating sheath comprising a conductive screen (12),
a system characterised in that the maintenance equipment (UC, 48, 49) is arranged to:
measure the insulation resistance (Rᵢₛₒ) of the screen (12) relative to the ground,
measure the electric potential (Pₑ) of the screen (12) relative to the ground, and
determine a global insulation resistance (Rᵢ) of the bundle of electric wires (11) relative to the conductive screen (12), using the result of the measurements of the insulation resistance (Rᵢₛₒ) and of the electric potential (Pₑ) of the screen.

11. System according to claim 10, in which the maintenance equipment is arranged to determine the global insulation resistance (Rᵢ) by means of the following relation or any other equivalent relation:
Rᵢ=Rᵢₛₒ (U−k)/(Pₑ−k)
“Rᵢ” being the global insulation resistance, “U” the service voltage, “Rᵢₛₒ” the insulation resistance of the screen, “Pₑ” the potential of the screen and “k” a constant.

12. System according to one of claims 10 and 11, in which the maintenance equipment is also arranged to determine an external insulation resistance (Rₑ) of the screen (12) relative to the ground, by means of the following relation or any other equivalent relation:
Rₑ=Rᵢₛₒ (U−k)/(U−Pₑ)
“Rₑ” being the external insulation resistance of the screen, “U” the service voltage, “Rᵢₛₒ” the insulation resistance of the screen, “Pₑ” the potential of the screen and “k” a constant.
